(19) United States
(12) Patent Application Publication
(10) Pub. No.: US 2026/0196794 A1
(43) Pub. Date: Jul. 9, 2026

(54) Laser medium arrangement and laser system

(71) Applicant: SCHOTT AG, Mainz (DE)

(72) Inventor: Andreas KOGLBAUER, Mainz (DE)

(21) Appl. No.: 19/134,110

(22) PCT Filed: Oct. 20, 2023
(86) PCT No.: PCT/EP2023/079240

§ 371 Date: May 29, 2025

(30) Foreign Application Priority Data
Dec. 2, 2022 (DE) 10 2022 132 112.6

(51) Int. Cl. H01S 3/06

(52) U.S. Cl. CPC H01S 3/0612

(57) ABSTRACT

A laser medium arrangement for generating or amplifying laser light by stimulated emission of photons, wherein the laser medium arrangement defines a longitudinal direction and a cross-section running transversely with respect to the longitudinal direction, and wherein the laser medium arrangement includes a plurality of structural elements each extending along the longitudinal direction and proportionally over the cross-section, wherein at least two different types of structural elements are included, namely a first type having a first refractive index and a second type having a second refractive index, wherein at least one of the structural elements includes a laser-active material. A laser system including such a laser medium arrangement is also provided.

The invention relates to a laser medium arrangement for generating or amplifying laser light by stimulated emission of photons, and to a laser system comprising such a laser medium arrangement.

### BACKGROUND

In a laser system, the laser medium is used to provide an inversion of occupation, in order to enable stimulated emission of photons and hence light amplification. The inversion of occupation is caused by supplying the laser medium with energy via a pump source. In order to increase distance traveled by the photons in the laser medium, an optical resonator can be used, in which the light is reflected several times, by means of which a direction of the laser light generated is also definable.

### SUMMARY OF THE INVENTION

Conventional resonator lasers of this design thus enable directed emission of light with high power density. However, the typically likewise high interference capability of the emitted light can lead to what are called speckle artefacts. Speckles are a phenomenon that can occur during illumination of rough object surfaces or transmission through scattering media. Unevenness, roughness or structures in the order of magnitude of the wavelength imprint random phase modulations on the wavefront of the light, which is manifested in the far field as a granular structure of random intensity maxima and minima. While this effect is exploited in some measurement principles for surface analysis, speckles constitute a disruptive factor in lighting applications, which corrupts homogeneous illumination.

By contrast, what are called random lasers can be used to achieve homogeneous, speckle-free illumination. In random lasers, generally disordered laser media are used and the light feedback to increase the distance traveled by the light in the laser medium is effected not by a resonator but in particular by scattering structures in the laser medium. This increases the dwell time of the photons in the laser medium, so that laser activity can arise. However, random lasers typically do not have a preferential direction for the emitted light and hence do not usually provide directed laser light.

Additionally known are random fiber lasers, in which, for example, scattering structures are provided in an optical fiber and serve to feed back the light. Although the enclosure of light in the optical fiber leads to release of directed light, there can again here also be speckle artefacts and hence inhomogeneous illumination.

It is an object of the invention to provide a laser medium which firstly enables directed delivery of light and secondly homogeneous illumination, with the particular aim of reducing or avoiding speckle artefacts. One aspect of the object of the invention is to enable these properties inherently by virtue of the laser medium itself, i.e. in particular without supplementary mode mixers or the like. It is a further object of the invention to provide a laser system which has the abovementioned properties of the directed and homogeneous, low-speckle light emission, and preferably to also provide a laser system in which at least the homogeneity and speckle resilience of the illumination can be reduced in an adjustable manner.

The invention relates to a laser medium arrangement for generation or amplification of laser light by stimulated emission of photons.

The laser medium arrangement defines a longitudinal direction and a cross section that extends transverse to longitudinal direction, and so the laser medium arrangement in particular defines a preferential direction for light propagation, which preferably extends in longitudinal direction.

The laser medium arrangement comprises a multitude of structure elements that each extend in longitudinal direction and over a proportion of the cross section, with inclusion of at least two different types of structure elements, namely a first type with a first refractive index and a second type with a second refractive index.

Accordingly, the multitude of structure elements encompassed may comprise at least one structure element of the first type and one or more structure elements of the second type, or, conversely, one or more structure elements of the first type and one structure element of the second type, or else may comprise both a plurality of structure elements of the first type and a plurality of structure elements of the second type. It is of course also possible for more than two different types, e.g. three different types, of structure elements to be included.

At least one of the structure elements comprises a laser-active material. However, it may also be the case that two or more or all structure elements of one type or else two or more or all structure elements of multiple types comprise a laser-active material, as will be set out in detail further down.

In some embodiments, the laser medium arrangement has a feedback device set up to return the proportion of the laser light generated to the laser-active material. The feedback device serves in particular to provide optical feedback so that the photons pass through the laser-active material for long enough to achieve macroscopic amplification.

For example, it may be the case for this purpose that the laser medium arrangement has two end faces which limit the expansion of the laser medium arrangement in longitudinal direction, where the end faces are preferably set up to return a proportion of the laser light generated to the laser-active material, especially in that the end faces form end surfaces that run perpendicular to longitudinal direction and/or are reflective.

It may alternatively be the case, for example, that the laser medium arrangement, especially the structure elements, especially the laser-active material, comprises embedded light-scattering structures set up to return the proportion of laser light generated to the laser-active material.

It may additionally be the case, for example, that the laser medium arrangement comprises an optical resonator which encompasses the end faces and is designed to return a proportion of the laser light generated to the laser-active material. Such an optical resonator may in particular comprise two mirrors, in which case at least one of these mirrors is partly transparent in order to emit laser light from the resonator, and is referred to as an external resonator in the context of the present disclosure.

The examples described above, which can be used alternatively or in combination, should not be considered to be exhaustive. Further variants or developments of the feedback device are possible, for example comprising at least one of the following properties: fiber Bragg grating, front end dielectric coating, high reflective coating (HR), partial reflective coating (PR) and/or anti-reflective coating (AR).

In further embodiments, the end faces may be beveled, especially in the case of an external resonator. This configuration assists prevention of an internal resonator competing with the external resonator. This embodiment may also be useful for a random laser.

In general, the end faces may have a non-90° angle to the longitudinal axis; for example, they may also be arranged at the Brewster angle with respect to the light propagating in the resonator.

With regard to the wavelength of the laser light that can be generated, several factors determine the emitted frequency spectrum. Amplification bandwidth Δλ is a measure of the wavelength range in which incident light can in principle be amplified by stimulated emission in the medium. This is a property of the laser medium and is dominated by the laser-active ion, and by the host material. In addition, the geometric constraints of the resonator define longitudinal modes, which limit the number of possible emission wavelengths, since, for constructive interference, after one cycle in the resonator, a multiple of 2π phase delay is preferred and in some cases even necessary. For a linear standing wave resonator, for example, the resonator length is a multiple of half the wavelength. The quality of the resonator defines here the narrowness of a single resonance peak. Typically, several longitudinal modes lie within the reinforcement profile, which can even lase simultaneously in the case of an inhomogeneous broadened laser medium, such as laser glasses. These broadband sources are the basis of various techniques, such as the generation of short laser pulses, or serve as light sources for special measurement methods, such as optical coherence tomography. Other applications, on the other hand, require monochromatic light, i.e. a source that ideally emits solely in a longitudinal mode. In order to achieve this, other frequency-selective elements such as Lyot filters, diffraction gratings, etalons or electrooptical modulators are incorporated into the resonator in order to increase the losses for unwanted modes to such an extent that they dominate the gain and force the resonator to operate in one mode longitudinally.

Preferably, there is a multitude of excitable transverse modes in the laser medium arrangement, and the laser medium arrangement, in particular the structure elements, in particular the geometry and/or arrangement thereof in the cross section of the laser medium arrangement, are designed such that such a multitude of transverse modes is excitable.

It may especially be the case that a mode density of at least 1000 per mm² is excitable in the laser medium arrangement, especially at least 5000 per mm², especially at least 10 000 per mm², especially at least 20 000 per mm², especially at least 50 000 per mm².

It may also especially be the case that at least 10 transverse modes are excitable in the laser medium arrangement, more preferably at least 100 transverse modes are excitable, more preferably at least 500 transverse modes are excitable, more preferably at least 1000 transverse modes are excitable.

In a preferred embodiment, the laser medium arrangement is set up to guide light in longitudinal direction of the laser medium arrangement and to optically collect light transverse to longitudinal direction.

The laser medium arrangement may especially be set up to transmit light in a transversely localized manner transverse to longitudinal direction, especially with a spatial resolution in the cross section of the laser medium arrangement, such that the laser medium arrangement forms an image guide.

The spatial resolution may preferably be higher than 5 line pairs per mm (lp/mm), more preferably higher than 10 lp/mm, or higher than 25 lp/mm, or higher than 50 lp/mm, or higher than 100 lp/mm, or higher than 150 lp/mm, or higher than 200 lp/mm.

The structure elements of the laser medium arrangement preferably extend over the cross section of the laser medium arrangement in such a way that a multitude of cross-sectional regions defined in the cross section of the laser medium arrangement each correspond to the cross section of a single structure element.

Accordingly, the structure elements especially run alongside one another, especially parallel to one another, in the longitudinal direction of the laser medium arrangement, and their cross sections each occupy a proportion of the area of the cross section of the laser medium arrangement and therefore each define a cross-sectional region of the cross section of the laser medium arrangement. Thus, the cross-sectional regions correspond in particular to the surface regions formed by the structure elements when viewing a cross-sectional area of the laser medium arrangement, i.e. the end faces in particular.

It may be the case that the structure elements, especially the cross-sectional regions thereof, are in a nonuniform arrangement in order to bring about a transverse Anderson localization transverse to longitudinal direction. For example, the nonuniform arrangement may be a random arrangement, but non-random nonuniform arrangements are also possible, as set out in detail further down.

As already described, the laser medium arrangement comprises a multitude of structure elements, including at least two different types of structure elements.

In some embodiments of the laser medium arrangement, it may then be the case that one structure element of the first type and a multitude of structure elements of the second type are included. The multitude of structure elements accordingly comprises in particular exactly one structure element of the first type. The structure element of the first type especially takes the form of a main body, for example in monolithic form, comprising or consisting of a first medium, where the first medium has the first refractive index. The structure elements of the second type may take the form of cavities in the main body, where the cavities preferably form the second refractive index, for example via the refractive index of air or a gas which may be present as medium in the cavities, or are filled with a second medium, in particular a solid-state material, where the second medium has the second refractive index.

In some embodiments of the laser medium arrangement, it may also be the case that a multitude of structure elements of the first type and a multitude of structure elements of the second type are included. In this case, the structure elements of the first type may take the form of bodies, especially in the shape of rods or tubes, comprising or composed of a first medium, where the first medium has the first refractive index. The structure elements of the second type may in this case take the form of bodies, especially in the shape of rods or tubes, comprising or consisting of a second medium, where the second medium has the second refractive index, and/or of cavities in the structure elements of the first type, where the cavities preferably form the second refractive index or are filled with a second medium, in particular a solid-state material, where the second medium has the second refractive index.

In particular, in the case that the structure elements of the second type are filled cavities in the structure elements of the first type, the structure elements may take the form of core-shell systems in that the core corresponds to the filled cavity.

In this case, rod-shaped or tubular bodies do not mean exclusively such a round cross-sectional geometry.

As already described, at least one of the structure elements of the laser medium arrangement comprises a laser-active material.

More specifically, for example, at least one structure element of the first type, preferably the structure elements of the first type, more preferably the first medium, may comprise the laser-active material.

In this case, in a development of the invention in which the laser medium arrangement comprises two different laser-active materials, it may be the case that at least one structure element of the second type, preferably the structure elements of the second type, more preferably the second medium, comprises a further, different laser-active material.

Conversely, for example, it is alternatively possible for at least one structure element of the second type, preferably the structure elements of the second type, more preferably the second medium, to comprise the laser-active material.

In this case, in a development of the invention in which the laser medium arrangement comprises two different laser-active materials, it may be the case that at least one structure element of the first type, preferably the structure elements of the first type, more preferably the first medium, comprises a further, different laser-active material.

The laser-active material may comprise a crystalline or amorphous solid-state material, especially a glass, as host material having extrinsic ion doping.

In particular, the laser-active material comprises a multicomponent glass, phosphate glass, fluorophosphate glass, silicate glass or quartz glass as host material comprising doping with ions of at least one transition metal and/or a rare earth, especially with 4fⁿ ground state.

Optionally, in embodiments in which the laser medium arrangement comprises at least two different laser-active materials, the other laser-active material may comprise a crystalline or amorphous solid-state material, especially a glass, as host material having extrinsic ion doping.

In particular, the other laser-active material comprises a multicomponent glass, phosphate glass, fluorophosphate glass, silicate glass or quartz glass as host material comprising doping with ions of at least one transition metal and/or a rare earth, especially with 4fⁿ ground state.

In one possible embodiment, the structure element(s) of the first type comprise a glass, for example a multicomponent glass, phosphate glass, fluorophosphate glass, silicate glass or quartz glass. It is also possible that the structure element(s) of the second type comprise a different glass, for example a multicomponent glass, phosphate glass, fluorophosphate glass, silicate glass or quartz glass. For example, the first type may include a phosphate glass and the second type may include a silicate glass, or vice versa. Another possibility is a difference in refractive index of at least 0.05 or preferably at least 0.075. There may also in particular be a difference in refractive index of especially at least 0.1, especially at least 0.2, especially at least 0.3, especially at least 0.4. It may further be the case here that the laser medium arrangement is set up to transmit light in a transversely localized manner transverse to longitudinal direction, especially with a spatial resolution in the cross section of the laser medium arrangement, such that the laser medium arrangement forms an image guide or that the structure elements are in a nonuniform arrangement in order to bring about a transverse Anderson localization transverse to longitudinal direction. In this way, it is surprisingly possible to use an image guide as a laser medium arrangement.

Some examples will once again be adduced hereinafter as to the way in which the laser medium arrangement with its structure elements and the laser-active material may be designed.

In one example, the laser medium arrangement may include a structure element of the first type, in the form of a main body, especially in monolithic form, comprising or composed of a first medium, especially glass, having the first refractive index. In addition, a multitude of structure elements of the second type may be included, which are in the form of cavities in the main body, which are filled with a second medium, in particular glass, in the form of a solid, which have the second refractive index and comprise the laser-active material.

In a further example, the laser medium arrangement may include a structure element of the first type, in the form of a main body, especially in monolithic form, comprising or composed of a first medium, especially glass, having the first refractive index and including the laser-active material. In addition, a multitude of structure elements of the second type may be included, in the form of cavities in the main body which form the second refractive index or which are filled with a second medium, especially a solid or a liquid having the second refractive index, and optionally including another, different laser-active material.

In a further example, the laser medium arrangement may include a multitude of structure elements of the first type, in the form of a body, especially in the shape of a rod or tube, comprising or composed of a first medium, especially glass, having the first refractive index and including the laser-active material. In addition, a multitude of structure elements of the second type may be included, in the form of a body, especially in the shape of a rod or tube, comprising or composed of a second medium, especially glass, having the second refractive index and optionally comprising a further, different laser-active material.

In a further example, the laser medium arrangement may include a multitude of structure elements of the first type, in the form of a body, especially in the shape of a rod or tube, comprising or composed of a first medium, especially glass, having the first refractive index and including the laser-active material. In addition, a multitude of structure elements of the second type may be included, which are in the form of cavities in the structure elements of the first type and which form the second refractive index or which are filled with a second medium, especially glass, having the second refractive index and optionally including a further, different laser-active material.

In a further example, the laser medium arrangement may include a multitude of structure elements of the first type, in the form of a body, especially in the shape of a rod or tube, comprising or composed of a first medium, especially glass, having the first refractive index. In addition, a multitude of structure elements of the second type may be included, which are in the form of cavities in the structure elements of the first type and are filled with a second medium, especially glass, having the second refractive index and including the laser-active material.

In relation to the refractive indices, it may be the case that the first refractive index of the structure elements of the first type and the second refractive index of the structure elements of the second type vary by at least, especially by at least 0.1, especially by at least 0.2, especially by at least 0.3, especially by at least 0.4. Another possibility is a difference in refractive index of at least 0.05 or of preferably at least 0.075. In order to achieve corresponding aforementioned differences in refractive index, a multicomponent glass in particular may be provided as a material of one or more structure elements.

As already described further up, the structure elements of the laser medium arrangement may extend over the cross section of the laser medium arrangement in such a way that a multitude of cross-sectional regions defined in the cross section of the laser medium arrangement each correspond to the cross section of a single structure element.

The ratio of the total area of the cross-sectional regions of the structure elements of the first type and the total area of the cross-sectional regions of the structure elements of the second type is, for example, within a range between 1:9 and 9:1, preferably within a range between 3:7 and 7:3, more preferably within a range between 4:6 and 6:4.

However, there is no intention to rule out the possibility that the ratio of the total area of the cross-sectional regions of the structure elements of the first type and the total area of the cross-sectional regions of the structure elements of the second type may also be within a range between 1:150 and 150:1, preferably within a range between 1:100 and 100:1, more preferably within a range between 1:50 and 50:1.

The total area of the cross-sectional regions of the structure elements for each type is, for example, at least 1/(10*T), preferably at least 1/(5*T), more preferably at least 1/(3*T) of the cross-sectional area, where T denotes the number of types of structure elements.

With regard to the lateral expansion of the structure elements, it may be the case that at least one cross-sectional region has a diameter of 100 nm to 50 μm, preferably 400 nm to 20 μm, more preferably 500 nm to 2000 nm.

With regard to the geometric shape of the structure elements, it may be the case that a cross-sectional region has an unround or polygonal, for example pentagonal or hexagonal, geometry.

As already described further up, the structure elements, in particular the cross-sectional regions thereof, preferably have a nonuniform arrangement, where such a nonuniform arrangement may in particular be random. It may alternatively be the case that the arrangement is nonuniform but determined by a predetermined rule, i.e. is not random.

The nonuniform arrangement of the structure elements, in particular the cross-sectional regions thereof, may especially be of the following form:
(a) a periodic positioning of structure elements, especially the cross-sectional regions thereof, wherein the periodically positioned structure elements are subject to mutual variation which is random and/or nonuniform but unambiguously fixed by a predetermined rule,
wherein the mutual variation of the periodically positioned structure elements preferably takes the form of a variation in the type of structure elements, the refractive index of the structure elements and/or the geometry, e.g. the shape, the diameter and/or the substructure, of the structure elements,
(b) an aperiodic positioning of structure elements, especially the cross-sectional regions thereof, wherein the aperiodic positions of the structure elements are random and/or nonuniform but unambiguously fixed by a predetermined rule,
wherein the structure elements optionally additionally have mutual variation which is random and/or nonuniform but unambiguously fixed by a predetermined rule,
and/or (c) a positioning of structure elements, especially the cross-sectional regions thereof, at periodic positions, where some of the periodic positions are populated and some of the periodic positions are unpopulated, and the assignment is random and/or nonuniform but unambiguously fixed by a predetermined rule,
wherein the structure elements optionally additionally have mutual variation which is random and/or nonuniform but unambiguously fixed by a predetermined rule.

The invention further relates to a laser system comprising a laser medium arrangement as described above, at least one pump source for optical excitation of the laser-active material, and an outcoupling point for outcoupling the laser light generated.

In one embodiment, the pump source may be set up to couple pump light longitudinally into an end face of the laser medium arrangement. One or more pump sources may also be set up to couple pump light longitudinally into both end faces of the laser medium arrangement. It is also possible that the pump source is set up to couple pump light into the laser medium arrangement in radial and/or tangential direction, for example laterally into the outer surface of the laser medium arrangement. The pump geometries mentioned should be considered to be merely illustrative. Other pump geometries may also exist, for example what is called double-clad geometry or other pump geometries.

More preferably, the laser system has a feedback device set up to return a proportion of the laser light generated to the laser-active material. The feedback device serves in particular to provide optical feedback so that the photons pass through the laser-active material for long enough to achieve macroscopic amplification.

For examples of a feedback device, reference is made to the details above. The laser systems may optionally include frequency-selective elements for manipulating the emission wavelength.

In one development, the laser system, especially the pump source, is set up in such a way that only a defined portion of the cross section of the laser medium arrangement is excitable via the pump source in order to reduce the spatial incoherence of the outcoupled laser light or to increase the spatial coherence of the outcoupled laser light.

In the case of longitudinal incidence of pump light on an end face of the laser medium arrangement, for example, the pump light spot on the end face may irradiate only a defined portion of the cross section. In the case of radial or tangential incidence of pump light, for example, it may likewise be the case, for example, that only a defined portion of the cross section is excited.

In particular, the laser system may preferably be set up and/or comprise means such that the defined portion of the cross section is variable, such that spatial coherence of the coupled laser light is adjustable.

In the case of longitudinal incidence of pump light on an end face of the laser medium arrangement, for example, the size and/or shape of the pump light spot on the end face may be adjustable. In the case of radial or tangential incidence of pump light, for example, the proportion of the excited cross section may likewise be adjustable.

The invention further relates to a method of generating or amplifying laser light by stimulated emission of photons, wherein a laser medium arrangement as described above is provided, wherein the laser medium arrangement comprises a multitude of structure elements that each comprise laser-active material, and wherein a pump source for optical excitation of the laser-active material is provided and the laser-active material is excited by means of the pump source, wherein laser-active material is simultaneously excited within a multitude of structure elements, especially in order to generate laser light with spatial incoherence, and/or wherein laser-active material is not excited in at least one structure element, preferably an adjustable multitude of structure elements, especially in order to reduce the spatial incoherence of the laser light, and/or wherein a defined portion of the cross section of the laser medium arrangement is excited by means of the pump source, especially in such a way that the transverse profile of the laser light corresponds to the geometry of the excited defined portion of the cross section.

### BRIEF DESCRIPTION OF THE DRAWINGS

The invention is described in detail hereinafter with reference to the drawings that follow. The figures show:

FIG. 1 a schematic diagram of a laser system having a laser medium arrangement with an optical resonator and a pump source for optical excitation of the laser-active material,

FIG. 2 a schematic diagram of a laser medium arrangement, with excitation only of a defined portion of the cross section of the laser medium arrangement,

FIGS. 3a, 3,b, 3c, 3d and 3e schematic diagrams of cross sections of different laser medium arrangements: (a), (b) and (c) two types of structure elements, and (d) and (e) three types of structure elements, where the cross-sectional areas of the structure elements are in a nonuniform arrangement,

FIGS. 4a and 4b schematic perspective views of two laser medium arrangements: (a) two types of structure elements, the cross-sectional areas of which are in a nonuniform arrangement on a grid and (b) a multitude of structure elements with nonuniform refractive indices (plurality of types) and/or nonuniform geometries (diameters),

FIG. 5 schematic illustration of various options for laser medium arrangements with a nonuniform arrangement of structure elements or cross-sectional regions thereof,

FIG. 6 schematic illustration of various aspects for variations between structure elements or cross-sectional regions thereof and possible combinations of these aspects,

FIGS. 7a and 7b schematic illustration of various further options for laser medium arrangements with a nonuniform arrangement of structure elements or cross-sectional regions thereof, wherein the laser medium arrangements each comprise a structure element of a first type and a multitude of structure elements of a second type,

FIGS. 8a, b, c, d, e, and f schematic illustration of various further options for laser medium arrangements with a nonuniform arrangement of structure elements or cross-sectional regions thereof, wherein the laser medium arrangements each comprise a multitude of structure elements of a first type and a multitude of structure elements of a second type and optionally further types

FIG. 9 schematic illustration of an embodiment comprising a master oscillator-power amplifier arrangement (MOPA) in which resonators or in particular systems with optical feedback, especially a presently described laser system for the master oscillator and a presently described laser medium arrangement is used as optical amplifier system, and a pump source generates a population inversion in the laser-active medium used as amplifier.

### DETAILED DESCRIPTION

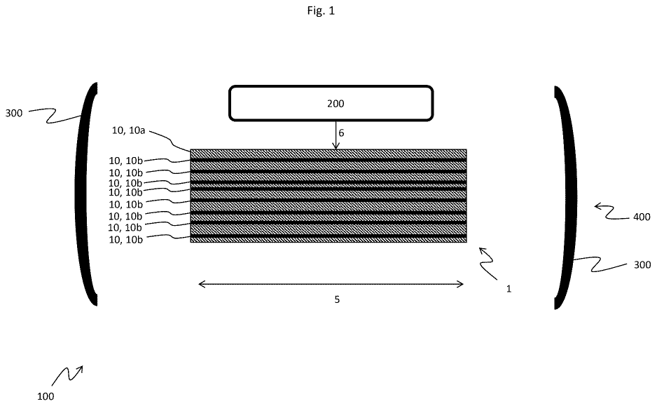

FIG. 1 shows a laser system 100 having a laser medium arrangement 1 comprising an optical resonator 300, a pump source 200 and an outcoupling point 400, which in this case is formed by a partly transparent mirror of the optical resonator 300. In the example shown, the pump source 200 is in a lateral arrangement and designed for the purpose of coupling pump energy into the laser medium arrangement 1 in radial direction 6, i.e. in particular perpendicularly to the longitudinal direction 5 of the laser medium arrangement 1.

The laser medium arrangement 1 comprises a multitude of structure elements 10 which each extend in longitudinal direction 5 and each over a proportion of the cross section of the laser medium arrangement 1. In the example shown, the laser medium arrangement 1 comprises exactly one structure element 10a in the form of a main body, which has a first refractive index, and a multitude of structure elements 10b present therein, each having a second refractive index and comprising laser-active material. Both types of structure elements 10a and 10b in this case take the form of solid-state bodies, for example each made of a glass, wherein the structure elements 10b of the second type, which comprise the laser-active material, especially have extrinsic ion doping. In cross section, the structure elements 10 form an nonuniform arrangement, which enables a transverse Anderson localization transverse to longitudinal direction 5 of the laser medium arrangement 1.

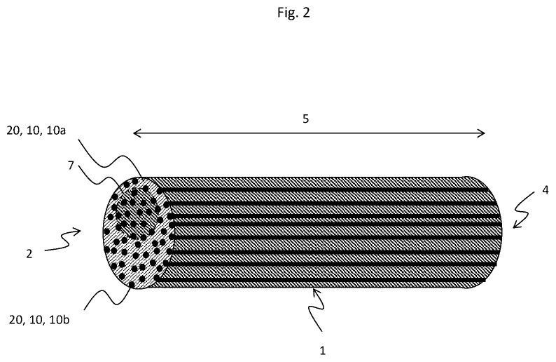

FIG. 2 once again shows the laser medium arrangement 1, which extends in longitudinal direction 5 from one end face 2 to the other end face 4, where the end face 2 can be seen in cross section. The structure elements 10 extend over the cross section of the laser medium arrangement 1 in such a way that a multitude of cross-sectional regions 20 defined in the cross section of the laser medium arrangement 1 each correspond to the cross section of a single structure element 10. In other words, each structure element 10 forms and/or takes up part of the cross-sectional area of the laser medium arrangement 1, and this portion is referred to as cross-sectional regions 20 of the structure element 10. In this example, the cross-sectional regions 20 of the structure elements have a nonuniform arrangement in that the cross-sectional regions of the structure elements of the second type 10b which comprise the laser-active material are in an aperiodic arrangement.

As can likewise be seen in FIG. 2, a laser system 100 or its pump source 200 (see FIG. 1) may be arranged in such a way that only a defined portion 7 of the cross section of the laser medium arrangement 1 is excitable or excited. In this way, it is possible to generate laser activity, for example, only in a portion of the structure elements of the second type 10b that comprises the laser-active material, by means of which the spatial incoherence of the coupled laser light is reducible. This may be the case for both radial and/or tangential and/or longitudinal coupling-in of pump energy. The defined portion 7 of the cross section may also be variable, such that the spatial incoherence of the coupled laser light is adjustable. In the case of longitudinal coupling-in of pump energy, i.e. coupling in longitudinal direction 5, the defined portion 7 of the cross section may correspond to the pump light spot.

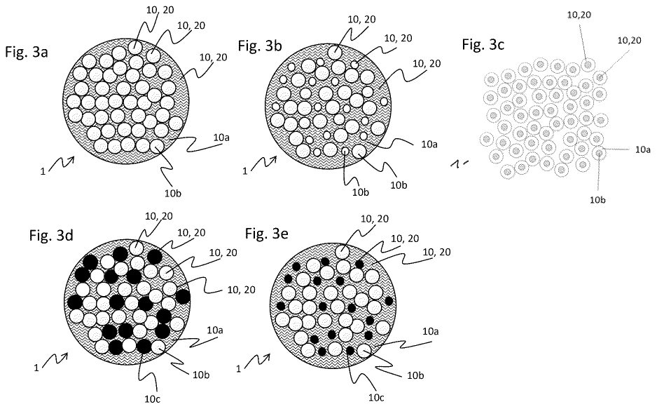

FIGS. 3a, 3b, 3c, 3d show various fundamental examples of laser medium arrangements 1. These fundamental representations serve to illustrate different variants of nonuniform arrangement of structure elements or cross-sectional regions thereof and the presence of laser-active material in the structure elements.

The laser medium arrangement in cross section shown in FIG. 3a has a structure element of a first type 10a in the form of a main body, which accommodates a multitude of structure elements of a second type 10b. The structure elements of the second type 10b may take the form, for example, of longitudinal cavities or hollow channels in the structure element of the first type 10a. The structure element of the first type 10a in the form of a main body comprises a first material having a first refractive index, and the structure elements of the second type 10b, in the form of cavities for example, form the second refractive index, for example by virtue of the air or another gas therein. The cross-sectional region 20 of the structure element of the first type 10a corresponds in this case to the cross-sectional area of the laser medium arrangement minus the holes defined by the cavities in this area, while the cross-sectional regions 20 of the structure elements of the second type 10b each correspond to the cross-sectional area of the cavities. The cavities in the main body may alternatively be filled with a second material, such that the structure elements of the second type 10b correspond to the filled cavities. As shown schematically in the figure, the cross-sectional regions 20 of the structure elements of the second type 10b are nonuniform in that their positions are distributed nonuniformly over the cross section, and in particular do not lie in a periodic grid. The structure element 10a in the form of a main body may in this case comprise the laser-active material. In the case that the cavities are filled, the structure elements 10b corresponding to the filled cavities may also comprise the laser-active material. It is also possible that, on the one hand, the structure element 10a comprises the laser-active material and, on the other hand, the structure elements 10b comprise another laser-active material.

The laser medium arrangement shown in cross section in FIG. 3b likewise has two types 10a, 10b of structure elements, namely again exactly one structure element 10a in the form of a main body with a first refractive index, and a multitude of structure elements 10b with a deviating second refractive index. In the example shown here, the cross-sectional regions 20 of the structure elements of the second type 10b are not only in a nonuniform arrangement but also have nonuniform geometries, in this case nonuniform diameters, there being a limited number of, namely two, different diameters in this case. It is possible that the structure element 10a comprises the laser-active material. It is also possible that the structure elements 10b comprise the laser-active material. Moreover, both the structure element 10a and the structure elements 10b may also comprise laser-active material, where preferably different laser-active materials are provided for the two types.

The laser medium arrangement shown in cross section in FIG. 3c again has two types 10a, 10b of structure elements, where the cross-sectional regions of the structure elements of the second type 10b are disposed in each case within a structure element of the first type 10a, especially in the form of core-shell systems. In this case, a multitude of structure elements of the first type 10a and a multitude of structure elements of the second type 10b are thus provided. The structure elements or their cross-sectional regions are nonuniform in that the structure elements of the first type 10a (which accommodate the structure elements of the second type 10b) are in a nonuniform, in particular aperiodic, arrangement over the cross section of the laser medium arrangement. It is possible that the structure elements 10a forming the shell comprise the laser-active material. It is also possible that the structure elements 10b forming the core comprise the laser-active material. Moreover, both the structure elements 10a and the structure elements 10b may also comprise laser-active material, where preferably different laser-active materials are provided for the two types.

The laser medium arrangements shown in cross section in FIG. 3d and FIG. 3e correspond in some aspects to the laser medium arrangements shown in FIGS. 3a and 3b, except that they have structure elements of three types 10a, 10b, 10c having different refractive indices. In particular, cavities in the structure element 10a in the form of a main body may be filled with various media. It is possible that the structure element 10a comprises the laser-active material. It is also possible that the structure elements 10b and/or 10c comprise the laser-active material. Moreover, both the structure element 10a and the structure elements 10b and/or 10c may comprise laser-active material, where preferably different laser-active materials are provided for the different types.

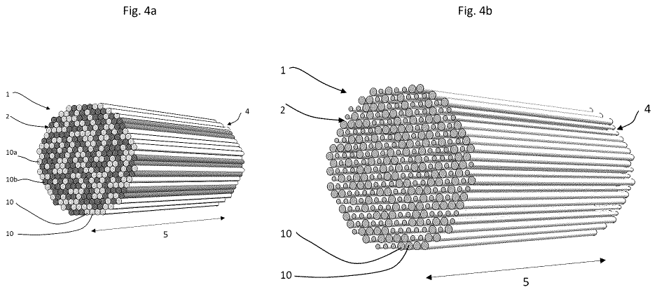

FIGS. 4a and 4b show two further examples of laser medium arrangements 1 which can be used in particular as image guides. The laser medium arrangements 1 in turn comprise a multitude of structure elements 10, which each extend in transport direction 5 from a first end face 2 to a second end face 4 of the laser medium arrangement 1 and are rod-shaped, for example.

The laser medium arrangement shown in FIG. 4a has a multitude of structure elements of a first type 10a and a multitude of structure elements of a second type 10b. In this example, the cross-sectional regions of the structure elements are arranged on a periodic grid. However, the structure elements have a nonuniform arrangement in that the structure elements of the first type 10a and of the second type 10b, and hence the refractive indices, are arranged and/or distributed nonuniformly, and/or a nonuniform population of periodic positions is present. It is possible that the structure elements 10a comprise the laser-active material. It is also possible that the structure elements 10b comprise the laser-active material. Moreover, both the structure element 10a and the structure elements 10b may also comprise laser-active material, where preferably different laser-active materials are provided for the two types.

The laser medium arrangement shown in FIG. 4b (b) in turn has a multitude of structure elements 10 arranged in a periodic grid, where the cross-sectional regions of the structure elements in this example have nonuniform geometries. The geometries may differ in particular in that the diameters of the structure elements or the cross-sectional regions thereof differ from one another. In addition, the structure elements 10 may have nonuniformity in that the refractive indices of the structure elements differ from one another. In this case, a discrete number of different refractive indices, e.g. two, three, four, etc. may be provided, or alternatively, in principle, continuous variation of the refractive index. At least some of the structure elements 10 include laser-active material in this variant.

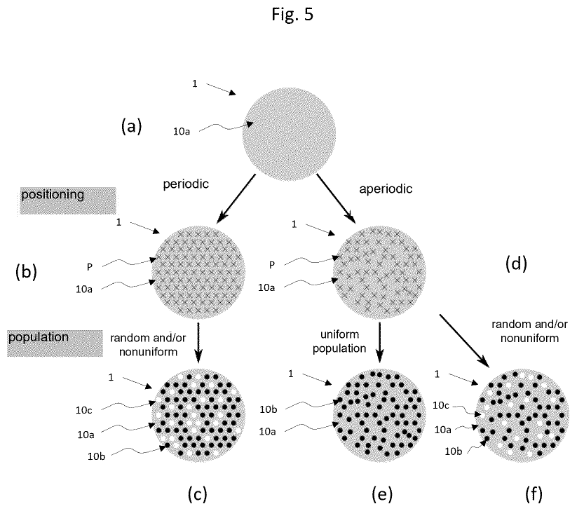

FIG. 5 shows different options for realizing a nonuniform arrangement using a tree diagram. Section (a) of the tree diagram shows a structure element 10a as a starting point; this may take the form, for example, of a matrix material (it is also possible that the structure element 10a takes the form of air or is absent). Section (b) shows a further starting point derived therefrom with the structure element 10a and a multitude of periodic positions P for population by structure elements, which then have periodic positioning. Section (d) shows a further starting point derived from section (a) with the structure element 10a and a multitude of aperiodic positions P for population by structure elements in order to obtain aperiodic positioning. Proceeding from the starting points shown in sections (b) and (d), population of positions P by structure elements gives rise to laser medium arrangements as described in detail below.

Proceeding from section (b), section (c) shows a laser medium arrangement 1 having structure elements 10b, 10c, the cross-sectional regions of which have periodic positioning and/or lie at periodic positions. The laser medium arrangement shown in section (c) has three types of structure elements 10a, 10b, 10c, which may each have a different refractive index. For example, the structure element 10a may take the form of a matrix material, and the structure elements 10b and 10c may be cavities in the matrix material filled with materials having different refractive indices.

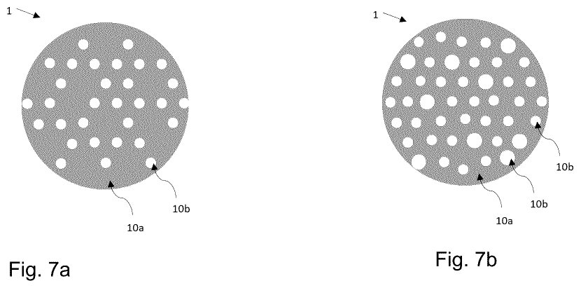

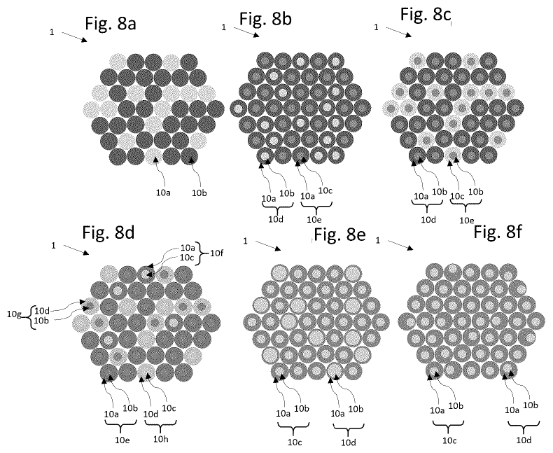

However, it is likewise possible that one of the materials of the structure elements 10b and 10c in turn corresponds to the matrix material of the structure element 10a, or that the (filled) cavities corresponding to these structure elements are absent in the matrix material (in this respect, see the text relating to FIG. 7a below). It is likewise possible that the structure element 10a takes the form of air or is absent, and the structure elements 10b and 10c adjoin one another (in this respect, see the text relating to FIG. 8a below).

The laser medium arrangement 1 shown in section (c) of the tree diagram of FIG. 5 has structure elements 10b, 10c with periodic positioning. However, the structure elements 10b, 10c are of different types, and the population of different types in the regular grid is nonuniform. In particular, the mutual variation of the structure elements 10b, 10c is thus nonuniform. Section (c) thus shows a case of a laser medium arrangement 1, wherein the structure elements or the cross-sectional regions thereof have a nonuniform arrangement. The term “arrangement” should be considered here to mean that the selection or population of the different types of structure elements 10b, 10c in the respective periodic positions is nonuniform.

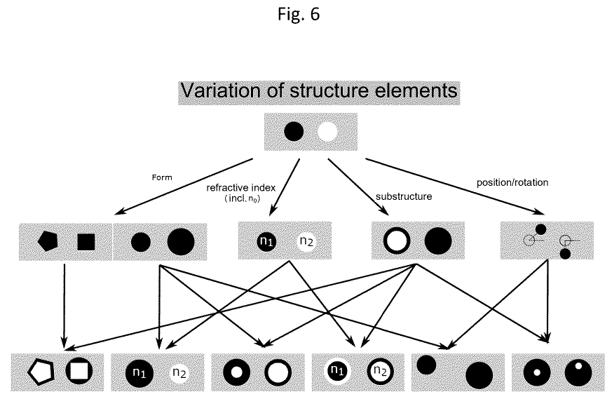

It is also possible that the structure elements 10b, 10c do not differ in terms of their refractive indices, i.e., for example, have the same refractive index or consist of the same material but vary with regard to other aspects (in this respect, see the text relating to FIG. 6 below). It is also possible that the structure elements 10b, 10c differ both in terms of their refractive indices and in terms of other aspects.

In particular, the structure element 10a may comprise the laser-active material, and/or the structure elements 10b and/or 10c may comprise the laser-active material or another laser-active material.

Proceeding from section (d), section (e) of FIG. 5 shows a laser beam arrangement 1 with two types of structure elements, namely the structure element 10a, which may take the form, for example, of a matrix material, and a multitude of structure elements 10b, which may take the form, for example, of cavities, in particular filled cavities, in the matrix material. In this case, the cross-sectional regions of the structure elements 10b are positioned aperiodically. The positioning of the structure elements 10b here may then constitute nonuniformity. In particular, the structure elements 10b of the second type may have nonuniform positions. Section (e) thus shows a case of a laser medium arrangement 1, wherein the structure elements or the cross-sectional regions thereof have a nonuniform arrangement. The term “arrangement” should be considered here to mean that the structure elements or some of the structure elements or the cross-sectional regions thereof are positioned aperiodically. In the case of section (e), what is envisaged in particular is that the structure elements 10b of the second type have a uniform refractive index, have uniform geometries and/or are formed uniformly, in particular identically, with regard to further aspects. This may be referred to as uniform population of aperiodic positions.

The structure element 10a may comprise the laser-active material and/or the structure elements 10b may comprise the laser-active material or another laser-active material.

By contrast, proceeding from section (d) of FIG. 5, section (f) shows a laser medium arrangement 1 in which aperiodic positioning of structure elements with simultaneously different types of structure elements 10b, 10c is envisaged. In this case, the nonuniformity of the arrangement may lie in aperiodic positioning of the structure elements 10b, 10c or in the population, i.e. the mutual variation, of the structure elements 10b, 10c, or in both the positioning and the population.

The structure element 10a may comprise the laser-active material and/or the structure elements 10b and/or 10c may comprise the laser-active material or another laser-active material.

FIG. 6 shows various options of mutual variations that may be exhibited by structure elements (middle row), and illustrative combinations of the variations (bottom row) that should not be considered to be exhaustive. The variations shown may be used in particular for nonuniform population of positions with structure elements. Structure elements having cross-sectional regions that are localized at periodic or else aperiodic positions, for example within a matrix material, may be subject to mutual variation with regard to their shape, with regard to their type or refractive index, with regard to their substructure and/or with regard to their rotation (and/or local position).

For example, variations in the geometries of the structure elements, especially in the cross-sectional regions thereof, may take the form of variations of shape (number of corners, diameter). Variations in geometry may also take the form of variations in substructure. The essence of a substructure may in particular be that a structure element, especially the cross-sectional region thereof, has at least two different regions of different refractive indices, especially a core and a surrounding shell (core-shell system).

In combination, for example, a first type of structure elements may have a polygonal shell and/or a polygonal core, and a second type of structure elements may have a round shell and a polygonal core (bottom row, first column). These two types of structure elements can then be used, for example, to populate periodic or aperiodic positions.

Moreover, for example, a first type of structure elements may have a first refractive index and a first diameter, and a second type of structure elements may have a second refractive index and a second diameter (bottom row, second column); or a first type of structure elements may have a core-shell system with a core having a first diameter, and a second type of structure elements may have a core-shell system with a core having a second diameter (bottom row, third column); or a first type of structure elements may have a core-shell system with a core having a first refractive index, and a second type of structure elements may have a core-shell system with a core having a second refractive index (bottom line, fourth column); or a first type of structure elements may have a first diameter and rotation around a point of rotation outside the structure element, and a second type of structure elements may have a second diameter and rotation around a point of rotation outside the structure element (bottom row, fifth column); or a first type of structure elements may have a core-shell system having a centered core, and a second type of structure elements may have a core-shell system with a core having rotation around a point of rotation outside the core (bottom row, sixth column), and so forth.

FIG. 7a shows a laser medium arrangement 1, which is comparable in each case to the laser medium arrangement from FIG. 5c in some aspects. The laser medium arrangement has a first structure element 10a, which may be formed e.g. as a matrix material. Moreover, the laser medium arrangement has a multitude of structure elements 10b, which may take the form, for example, of cavities in the matrix material. The structure elements 10b lie at periodic sites, but not all periodic sites are populated by a structure element. FIG. 7a thus shows a case of a laser medium arrangement 1, where the structure elements or the cross-sectional regions thereof have a nonuniform arrangement uniquely defined by a predetermined rule. The term “arrangement” should be considered here to mean that the structure elements or some of the structure elements or the cross-sectional regions thereof lie at periodic sites, with some of the periodic sites populated and some of the periodic sites unpopulated. It is possible that the structure element 10a comprises the laser-active material. It is also possible that the structure elements 10b comprise the laser-active material, especially when these structure elements take the form of filled cavities. Moreover, both the structure element 10a and the structure elements 10b may also comprise laser-active material, where preferably different laser-active materials are provided for the two types.

FIG. 7b shows a laser medium arrangement 1, which is comparable in each case to the laser medium arrangement from FIG. 5f in some aspects. The laser medium arrangement has a first structure element 10a, which may be formed e.g. as a matrix material. Moreover, the laser medium arrangement comprises a multitude of structure elements 10b with a first diameter and a multitude of structure elements 10c with a second diameter. In this example, the structure elements are positioned aperiodically. FIG. 7b thus shows a case of a laser medium arrangement 1, wherein the structure elements or the cross-sectional regions thereof have a nonuniform arrangement. The term “arrangement” should be considered here to mean that the structure element or some of the structure elements or the cross-sectional regions thereof are positioned aperiodically, and/or where the structure elements have a nonuniform mutual variation, where the variation is in the form of two types of structure elements, for example with different diameters. It is possible that the structure element 10a comprises the laser-active material. It is also possible that the structure elements 10b and/or 10c comprise laser-active material, especially when these structure elements are in the form of filled cavities. Moreover, both the structure element 10a and the structure elements 10b and/or 10c may also comprise laser-active material, where preferably different laser-active materials are provided for the types.

FIGS. 8a to 8f show some laser medium arrangements 1, each with a multitude of structure elements of a first type and a multitude of structure elements of a second type (and sometimes further types in FIG. 8d). The laser medium arrangements 1 shown here especially have no matrix material, instead of which the structure elements adjoin one another. A common factor in the laser medium arrangements 1 shown in FIGS. 8a to 8f is that the structure elements of the various types, in particular the cross-sectional regions thereof, are positioned periodically, but the population of the periodic positions with the types of the structure elements is nonuniform. The laser medium arrangements 1 shown in FIG. 8 thus have the feature that the structure elements or cross-sectional regions thereof have a nonuniform arrangement, where the term “arrangement” should be considered here to mean that the selection or population of the different types of structure elements at the periodic positions is nonuniform.

FIG. 8a shows, for instance, a laser medium arrangement 1 having a multitude of structure elements 10a and a multitude of structure elements 10b having different refractive indices. It is possible that the structure elements 10a comprise the laser-active material. It is also possible that the structure elements 10b comprise the laser-active material. Moreover, both the structure elements 10a and the structure elements 10b may also comprise laser-active material, where preferably different laser-active materials are provided for the two types.

FIG. 8b shows a laser medium arrangement 1 having a multitude of structure elements 10d and a multitude of structure elements 10e having different refractive indices and a different substructure, where the substructure is defined by the substructure elements 10a and 10b (with refractive indices a and b) and 10a and 10c (with refractive indices a and c). The essence of the substructure here is that the structure elements 10d and 10e are in the form of core-shell systems with different cores. At least one of types 10a, 10b, 10c, 10d, 10e preferably comprises the laser-active material. It is also possible that several types comprise the laser-active material or that some types comprise a different laser-active material.

FIG. 8c similarly shows a laser medium arrangement 1 having a multitude of structure elements 10d and a multitude of structure elements 10e having different refractive indices and a different substructure, where the substructure is defined by the substructure elements 10a and 10b (with refractive indices a and b) and 10c and 10b (with refractive indices c and b). The essence of the substructure here is that the structure elements 10d and 10e are in the form of core-shell systems with different shells. At least one of types 10a, 10b, 10c, 10d, 10e again preferably comprises the laser-active material. It is also possible that several types comprise the laser-active material or that some types comprise a different laser-active material.

FIG. 8d similarly shows a laser medium arrangement 1 having a multitude of structure elements 10e, a multitude of structure elements 10f, a multitude of structure elements 10g, and a multitude of structure elements 10h, which have different refractive indices and a different substructure, where the substructure is defined by the substructure elements 10a and 10b (with refractive indices a and b) or 10a and 10c (with refractive indices a and c) or 10b and 10d (with refractive indices b and d) or 10c and 10d (with refractive indices c and d). The essence of the substructure here is that the structure elements 10e, 10f, 10g and 10h are in the form of core-shell systems with both different cores and different shells. At least one of types 10a, 10b, 10c, 10d preferably comprises the laser-active material. It is also possible that several types comprise the laser-active material or that some types comprise a different laser-active material.

FIG. 8e shows a laser medium arrangement 1 having a multitude of structure elements 10c and a multitude of structure elements 10d having different geometries and a different substructure, where the substructure of the structure element 10c is defined by the substructure elements 10a and 10b (with refractive indices a and b and a first core diameter), and the substructure of the structure element 10d by the substructure elements 10a and 10b (with refractive indices a and b and a second core diameter). One of types 10a, 10b preferably comprises the laser-active material. It is also possible that both types comprise the laser-active material or that one type comprises the laser-active material and the other type comprises another laser-active material.

FIG. 8f shows a laser medium arrangement 1 having a multitude of structure elements 10c and a multitude of structure elements 10d having different geometries and a different substructure, where the substructure of the structure element 10c is defined by the substructure elements 10a and 10b (with refractive indices a and b and a centrally positioned core), and the substructure of the structure element 10d by the substructure elements 10a and 10b (with refractive indices a and b and an eccentrically positioned core). One of types 10a, 10b preferably comprises the laser-active material. It is also possible that both types comprise the laser-active material or that one type comprises the laser-active material and the other type comprises another laser-active material.

Aside from use in resonators or more generally systems with optical feedback, laser-active media can be used in particular as optical amplifier systems. In this case, a pump source generates an inversion of population in the laser-active medium used as an amplifier.

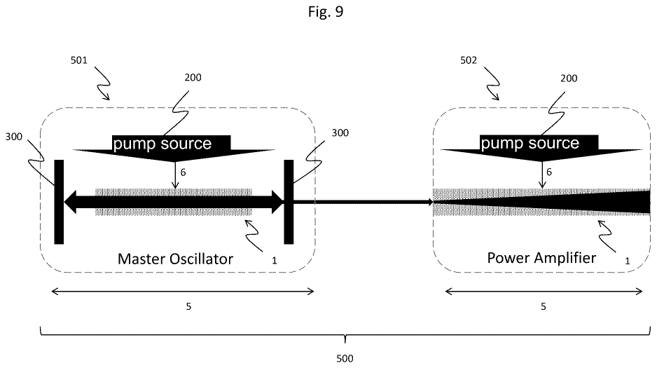

Such an embodiment is shown in FIG. 9.

The light to be amplified comes emitted from an external laser system 100 and is preferably unidirectionally amplified in the laser medium arrangement 1 shown in FIG. 9 on the right-hand side thereof. Any possible amplification of spontaneously emitted photons (ASE—amplified spontaneous emission) is merely a parasitic effect here.

In this case, a laser system arrangement 500 is provided, comprising a presently disclosed first laser system 100, especially as master oscillator 501, and a presently disclosed laser medium arrangement 1, especially as power amplifier 502, in which laser light generated by the laser system 100 by stimulated emission of photons is directed into the laser medium arrangement 1 and is amplified in the laser medium arrangement 1 by stimulated emission of photons.

In the presently disclosed embodiments, the laser system arrangement 500 and in particular the laser system 100 thereof may be operated in continuous operation.

In further configurations of the presently disclosed embodiment, the laser system arrangement 500 and in particular the laser system 100 thereof is operated in a pulsed manner.

Such systems can be used, for example, in the power scaling of laser systems, in which case they comprise, as described above, a master oscillator and at least one power amplifier.

In particular, it is also possible for more than one laser medium arrangement 1, as presently disclosed, to be encompassed by the laser system arrangement 500, especially as power amplifier 502 in each case.

In this case, it is primarily the master laser or seed laser 501 that determines the properties of the emitted light by virtue of its resonator configuration, which determine its respective properties such as wavelength, line width or pulse duration.

The seed light in particular which is emitted by the master laser or seed laser 501 and is to be amplified is then amplified up in the power stage decoupled therefrom, the above-described power amplifier 502 (see FIG. 9), which typically has different requirements than the master oscillator 501, for example in terms of power stability.

Examples of such arrangements are also trapezoidal amplifiers or fiber amplifiers.

In particular, the invention also permits selective amplification in regions transverse to the direction of propagation, which follows the intensity profile of the seed source, and hence the intensity profile of the laser system 501, where the latter is substantially preserved in the propagation and amplification by the laser medium of the power amplifier 502, and hence the laser medium arrangement 1.

Another field of application for optical amplifiers is in the field of data communication, where signal losses over long transport distances are compensated for. If the data rate is increased by using spatial multiplexing, which is also referred to as SDM-Space Division Multiplexing, distribution of the data transverse to the direction of transport undertaken via different modes or channels, this can also be achieved by means of a corresponding, presently disclosed amplifier system with a laser system arrangement 500.

A laser medium arrangement 1 used here according to the present invention permits this owing to the high mode density, and the associated transversely localized optical amplification in a particularly advantageous manner.

1-24. (canceled)

25. A laser medium arrangement for generating or amplifying laser light by stimulated emission of photons, the laser medium arrangement defining a longitudinal direction and a cross section that runs perpendicular to longitudinal direction, the laser medium arrangement comprising:
a plurality of structure elements each extending in the longitudinal direction and partly over the cross section, the plurality of structure elements including a first type having a first refractive index and a second type having a second refractive index,
wherein at least one of the structure elements comprises a laser-active material.

26. The laser medium arrangement recited in claim 25 further comprising a feedback device set up to return a proportion of the laser light generated to the laser-active material.

27. The laser medium arrangement as recited in claim 25 further comprising one or more frequency-selective elements, especially one or more of the following components: Lyot filter, diffraction grating, etalon, electrooptical modulator.

28. The laser medium arrangement as recited in claim 25 wherein transverse modes are excitable in the laser medium arrangement, and wherein a mode density of at least 1000 per mm² is excitable in the laser medium arrangement or wherein at least 10 transverse modes are excitable in the laser medium arrangement.

29. The laser medium arrangement as recited in claim 25 wherein the laser medium arrangement is set up to guide light in longitudinal direction of the laser medium arrangement and to optically collect light transverse to longitudinal direction, or
wherein the laser medium arrangement is set up to transmit light in a transversely localized manner transverse to longitudinal direction, or
wherein the spatial resolution is higher than 5 line pairs per mm, or
wherein the structure elements extend over the cross section of the laser medium arrangement in such a way that a multitude of cross-sectional regions defined in the cross section of the laser medium arrangement each correspond to the cross section of a single structure element, or
wherein the structure elements are in a nonuniform arrangement in order to bring about a transverse Anderson localization transverse to longitudinal direction.

30. The laser medium arrangement as recited in claim 25 wherein one of the structure elements is of the first type and a plurality of the structure elements are of the second type, and
wherein the structure element of the first type takes the form of a main body comprising a first medium, wherein the first medium has the first refractive index, and
wherein the structure elements of the second type take the form of cavities in the main body, wherein the cavities form the second refractive index or are filled with a second medium, wherein the second medium has the second refractive index.

31. The laser medium arrangement as recited in claim 25 wherein a plurality of the structure elements are of the first type and a plurality of structure elements are of the second type,
wherein the structure elements of the first type take the form of bodies comprising a first medium, wherein the first medium has the first refractive index,
and wherein the structure elements of the second type take the form of further bodies comprising a second medium, wherein the second medium has the second refractive index or
wherein the structure elements of the second type take the form of cavities in the structure elements of the first type, wherein the cavities form the second refractive index or are filled with the second medium.

32. The laser medium arrangement recited in claim 25 wherein at least one of the structure elements of the first type comprises the laser-active material, and wherein at least one structure element of the second type comprises a further, different laser-active material.

33. The laser medium arrangement as recited in claim 25 wherein the laser-active material comprises a crystalline or amorphous solid as host material having extrinsic ion doping.

34. The laser medium arrangement as recited in claim 25 wherein one structure element of plurality of structure elements is of the first type and in the form of a main body having the first refractive index, and
wherein a plurality of the structure elements of the second type are in the form of cavities in the main body filled with a second medium in solid form and having the second refractive index and comprise the laser-active material.

35. The laser medium arrangement as recited in claim 30 wherein the structure element of the first type includes the laser-active material.

36. The laser medium arrangement as claimed in claim 25 wherein a plurality of the structure elements are of the first type and a plurality of structure elements are of the second type,
wherein the structure elements of the first type take the form of bodies comprising a first medium, wherein the first medium has the first refractive index and wherein the structure elements of the first type includes the laser-active material,
and wherein the structure elements of the second type take the form of further bodies comprising a second medium, wherein the second medium has the second refractive index.

37. The laser medium arrangement as recited in claim 25 wherein a plurality of the structure elements are of the first type and are in the form of a body, and
wherein a plurality of the structure elements are of the second type in the form of cavities in the structure elements of the first type and forming the second refractive index or
filled with a second medium.

38. The laser medium arrangement as recited in claim 25 wherein a plurality of the structure elements are of the first type and are in the form of a body having the first refractive index, and
wherein a plurality of the structure elements are of the second type in the form of cavities in the structure elements of the first type are filled with a second medium, especially glass, having the second refractive index and including the laser-active material.

39. The laser medium arrangement as recited in claim 25 wherein the first refractive index of the structure elements of the first type and the second refractive index of the structure elements of the second type vary by at least 0.05.

40. The laser medium arrangement as recited in claim 25 wherein the structure elements extend over the cross section of the laser medium arrangement in such a way that a plurality of cross-sectional regions defined in the cross section of the laser medium arrangement each correspond to the cross section of a single structure element, and
wherein the ratio of the total area of the cross-sectional regions of the structure elements of the first type and the total area of the cross-sectional regions of the structure elements of the second type is within a range between 1:9 and 9:1, or
wherein the total area of the cross-sectional regions of the structure elements for each type is at least 1/(10*T) of the cross-sectional area, where T denotes the number of types.

41. The laser medium arrangement as recited in claim 25 wherein the structure elements extend over the cross section of the laser medium arrangement in such a way that a plurality of cross-sectional regions defined in the cross section of the laser medium arrangement each correspond to the cross section of a single structure element of the structure elements, and
wherein the structure elements have a nonuniform arrangement.

42. A laser system comprising:
a laser medium arrangement as recited in claim 25;
at least one pump source for optical excitation of the laser-active material, and
an outcoupling site for outcoupling of the laser light generated.

43. The laser system as recited in claim 42 wherein the laser system (100) is set up such that only a defined portion of the cross section of the laser medium arrangement is excitable by the pump source, in order to reduce spatial incoherence of the coupled laser light.

44. A laser system arrangement comprising
a first laser system; and
at least one laser medium arrangement recited in claim 25;
wherein laser light generated by the laser system by stimulated emission of photons is directed into the laser medium arrangement and amplified in the laser medium arrangement by stimulated emission of photons.

45. The laser system arrangement as recited in claim 44 wherein the at least one laser medium arrangement includes a plurality of laser medium arrangements.

46. The laser system arrangement as recited in claim 44 wherein the laser system is operated in continuous operation.

47. The laser system arrangement as recited in claim 44 wherein the laser system is operated in a pulsed manner.

48. A method of generating or amplifying laser light by stimulated emission of photons,
providing the laser medium arrangement as recited in claim 25, the laser medium arrangement comprises a multitude of structure elements that each comprise laser-active material, and wherein a pump source for optical excitation of the laser-active material is provided and the laser-active material is excited by the pump source,
wherein laser-active material is simultaneously excited within a multitude of structure elements, or
wherein laser-active material is not excited in at least one structure element, or
wherein a defined portion of the cross section of the laser medium arrangement is excited by the pump source.
